(19) United States
(12) Patent Application Publication
(10) Pub. No.: US 2023/0312377 A1
(43) Pub. Date: Oct. 5, 2023

(54) NON-MEMBRANE DEIONIZATION AND ION-CONCENTRATING APPARATUS AND NON-MEMBRANE DEIONIZATION AND ION-CONCENTRATING MODULE

(71) Applicant: NATIONAL TSING HUA UNIVERSITY, HSINCHU (TW)

(72) Inventors: Chi-Chang HU, HSINCHU (TW); Yi-Heng TU, HSINCHU (TW); Yu-Hsiang YANG, HSINCHU (TW); Jen-Huang HUANG, HSINCHU (TW)

(21) Appl. No.: 17/938,679

(22) Filed: Oct. 7, 2022

(30) Foreign Application Priority Data
Apr. 1, 2022 (TW) 111112909

(51) Int. Cl. C02F 1/461; C02F 1/467

(52) U.S. Cl. CPC C02F 1/46109; C02F 1/4672; C02F 1/4676; C02F 2001/46138; C02F 2301/08; C02F 2201/4611; C02F 2103/08

(57) ABSTRACT

A non-membrane deionization and ion-concentrating apparatus is connected to a power supply and includes a microfluidic channel, two current collectors and an electroactive material. The microfluidic channel is disposed between the two current collectors, and the power supply applies a voltage to the two current collectors. The electroactive material is coated and connected to at least one of the two current collectors, wherein the electroactive material has a reversible redox ability.

### RELATED APPLICATIONS

This application claims priority to Taiwan Application Serial Number 111112909, filed Apr. 1, 2022, which is herein incorporated by reference.

### BACKGROUND

### Technical Field

The present disclosure relates to a deionization and ion-concentrating apparatus and a deionization and ion-concentrating module. More particularly, the present disclosure relates to a non-membrane deionization and ion-concentrating apparatus, and a non-membrane deionization and ion-concentrating module.

### Description of Related Art

Desalination is a technology that removes salt and minerals from brackish water or seawater to obtain fresh water. Known methods for desalination include distillation (multistage flash distillation process and multi-effect distillation process), ion exchange, membrane treatment, etc. A common method of the membrane treatment is a reverse osmosis (RO) process. The RO process is often used for desalination of brackish water and seawater, but it has the problems of high energy consumption, and membrane soiling and aging.

Another method for desalination of brackish water and seawater is capacitive deionization (CDI). The electrodes in the conventional CDI process are carbon materials with a high specific surface area (activated carbon, carbon nanotubes, graphene, etc.), but the efficiency is poor. In order to improve the desalination efficiency, those involved in research in the related fields add an ion exchange membrane on the surface of the carbon electrodes. However, the ion exchange membrane has the disadvantages of high maintenance cost, complicated operation, soiling, and aging. Therefore, the application of the CDI technique is still limited.

Therefore, those in the industry are endeavoring to find ways to improve the efficiency of desalination, simplify the operation, reduce the cost, and also improve the disadvantages of the membrane treatment.

### SUMMARY

According to one aspect of the present disclosure, a non-membrane deionization and ion-concentrating apparatus is connected to a power supply and includes a microfluidic channel, two current collectors and an electroactive material. The microfluidic channel is disposed between the two current collectors, and the power supply applies a voltage to the two current collectors. The electroactive material is coated and connected to at least one of the two current collectors, wherein the electroactive material has a reversible redox ability.

According to another aspect of the present disclosure, a non-membrane deionization and ion-concentrating module is connected to a power supply and includes a plurality of the non-membrane deionization and ion-concentrating apparatuses according to the aforementioned aspect. The non-membrane deionization and ion-concentrating apparatuses are connected to each other.

Understanding of these and other features, aspects, and advantages of the present disclosure will be improved with reference to the following description and appended claims.

### BRIEF DESCRIPTION OF THE DRAWINGS

The present disclosure can be more fully understood by reading the following detailed description of the embodiments, with reference made to the accompanying drawings as follows:

FIG. 1 is a schematic view of a non-membrane deionization and ion-concentrating apparatus according to an example of an embodiment of the present disclosure.

FIG. 2 is a structure schematic view of the non-membrane deionization and ion-concentrating apparatus of FIG. 1.

FIG. 3 is a structure schematic view of the non-membrane deionization and ion-concentrating apparatus according to another example of the embodiment of the present disclosure.

FIG. 4 is a schematic view of a non-membrane deionization and ion-concentrating module according to an example of another embodiment of the present disclosure.

FIG. 5 is a schematic view of a non-membrane deionization and ion-concentrating module according to another example of another embodiment of the present disclosure.

FIG. 6 is a comparison result of the removal performance of Example 1 of the present disclosure and a normal deionization apparatus.

FIG. 7 is a relationship diagram between the flow rate and the salt removal capacity of Example 1 processing brackish water with various salt concentrations.

FIG. 8 is a relationship diagram between the salt removal rate and operation time of Example 1.

FIG. 9 is a relationship diagram between the removal capacity of various charged species and the liquid flow rate according to Example 1.

FIG. 10 is a result of Example 1 processing in seawater and salted underground water.

FIG. 11 is a relationship diagram between the salt removal capacity/salt-concentrating capacity and operation time in salinized water with various concentrations according to Example 1.

FIG. 12 is a relationship diagram between the ion selectivity and operation time according to Example 1.

FIG. 13 is a relationship diagram between the salt removal capacity and operation time as well as between the salt removal percentage and operation time of Example 2.

FIG. 14 is a cycling test diagram for the salt removal capacity against operation time of Example 3.

### DETAILED DESCRIPTION

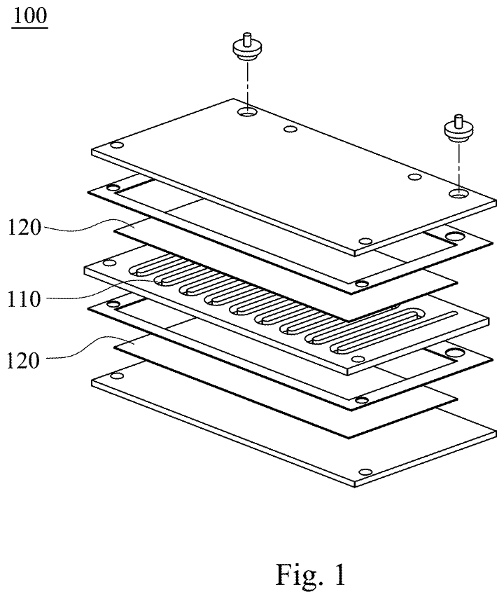

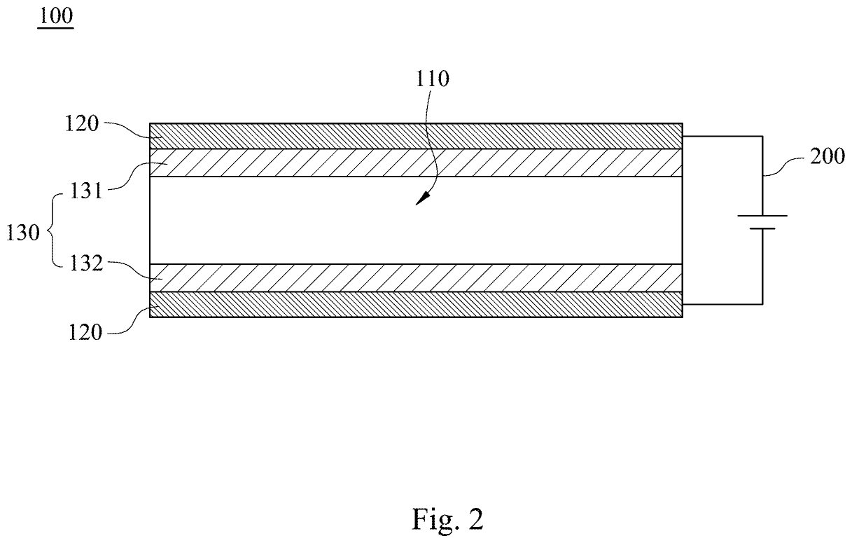

Reference is made to FIGS. 1 and 2. FIG. 1 is a schematic view of a non-membrane deionization and ion-concentrating apparatus 100 according to an example of an embodiment of the present disclosure. FIG. 2 is a structure schematic view of the non-membrane deionization and ion-concentrating apparatus 100 of FIG. 1. As shown in FIGS. 1 and 2, the non-membrane deionization and ion-concentrating apparatus 100 is connected to a power supply 200 and includes a microfluidic channel 110, two current collectors 120 and an electroactive material 130. It is to be noted that, in FIG. 1, the number of the microfluidic channel 110 and the current collectors 120 can be determined according to actual requirements, and the present disclosure is not limited to the shown example.

The microfluidic channel 110 is disposed between the two current collectors 120. The microfluidic channel 110 is used for the passage of a fluid. The microfluidic channel 110 is a micrometer-sized structure. In greater detail, a width of the microfluidic channel 110 can be 1 μm to 300 μm. The width refers to the spacing between the current collectors 120 including the electroactive material 130. The arrangement of the microfluidic channel 110 can effectively improve the reaction area ratio between the aqueous media and the electrode. Therefore, the ion adsorption and ion desorption efficiencies of the non-membrane deionization and ion-concentrating apparatus 100 can be greatly improved.

The power supply 200 is connected to the two current collectors 120. When the power supply 200 applies a voltage to the two current collectors 120, one of the current collectors 120 is formed as a positive electrode, and the other one of the collectors 120 is formed as a negative electrode. Specifically, the current collectors 120 can be a conductive material such as metal, alloy, or carbon.

The electroactive material 130 is coated and connected to at least one of the two current collectors 120. When the fluid passes through the microfluidic channel 110, the fluid contacts the electroactive material 130. Specifically, the electroactive material 130 has a reversible redox ability. The electroactive material 130 can be pseudo-capacitive-type or battery-type materials.

In greater detail, the ions in the aqueous media can be adsorbed or removed by the redox reaction of the electroactive material 130. The electroactive material 130 has excellent reversibility of the redox reaction, which helps to improve the efficiency of the electrochemical reaction and lifetime of electrodes. The electroactive material 130 can perform oxidation and reduction which promote the efficiency of the electrochemical reaction. Further, the electroactive material 130 has a high theoretical specific capacity. Therefore, the electrosorption capacity of the non-membrane deionization and ion-concentrating apparatus 100 can be effectively increased, and the deionization and ion concentration efficiencies thereof can be further enhanced.

The electroactive material 130 can be coated on the surface of the current collectors 120 by electroplating, electrophoretic deposition, painting, dip coating or spraying. The mass loading of the electroactive material can be from 0.5 mg/cm² to 25 mg/cm². In greater detail, the effectiveness of the electroactive material 130 is highly dependent on its weight. According to the dissimilarity between the positive electrode materials and the negative electrode materials, the optimal mass range and mass ratio of the electroactive material 130 can be configured after electrochemical analysis and electric charge balance. When the electroactive material 130 of the present disclosure satisfies the above conditions, the efficiency of the non-membrane deionization and ion-concentrating apparatus 100 can be effectively promoted.

In FIG. 2, the electroactive material 130 can include an electroactive material coated on a positive electrode 131 and an electroactive material coated on a negative electrode 132. By changing and arranging the kinds of electroactive materials, different ions can be selectively adsorbed.

Specifically, the electroactive material coated on the positive electrode 131 can be a metal, an alloy, a transition metal oxide, a transition metal sulfide, a transition metal carbide, an anionic polymer, a Prussian blue analog, an organic electrode material, an organometallic compound, a polyoxymethylene, a composite of the above materials or a composite of the above materials with a conductive carbon material. In greater detail, the metal can be Ag, Bi or Cu. The alloy can be a binary alloy or a ternary alloy composed of Ag, Bi or Cu. The transition metal oxide can be MnO₂, Mn₃O₄, TiO₂, CeO₂, Co₃O₄, ZrO₂, Fe₂O₃, VOₓ, Fe₃O₄ or RuO₂. The transition metal sulfide can be MoS₂, TiS₂, NiS, CoS or NiCo₂S₄. The transition metal carbide can be MXene (M can be Fe, Co, Ni or Cu) or MoC. The anionic polymer can be NaTi₂(PO₄)₃, Na₃V₂(PO₄)₃ or FePO₄. The Prussian blue analog can be MFe(CN)₆, wherein M can be Fe, Co, Ni or Cu. The organic electrode material can be polypyrrole, polyaniline, polythiophene, poly(3,4-ethylenedioxythiophene) or poly[N,N′-(ethane-1,2-diyl)-1,4,5,8-naphthalenetetracarboxiimide]. The organometallic compound can be ferrocene or metal-organic framework. The present disclosure is not limited to these given examples.

The electroactive material coated on the negative electrode 132 can be a metal, an organic electrode material, an organometallic compound, a transition metal carbide, a composite of the above materials or a composite of the above materials with a conductive carbon material. In greater detail, the metal can be Bi, Hg or Ag. The organic electrode material can be polypyrrole, polyaniline, polythiophene, poly(3,4-ethylenedioxythiophene) or PTMA (poly (2,2,6,6-tetramethylpiperidinyloxy methacrylate)). The organometallic compound can be ferrocene or metal-organic framework. The transition metal carbide can be two-dimensional transition metal carbide or molybdenum carbide. The present disclosure is not limited to these given examples.

The electroactive material 130 can be ion-selective for an ion to be processed. Therefore, the processing efficiency of the non-membrane deionization and ion-concentrating apparatus 100 can be improved. For example, the electroactive material 130 can be a Prussian blue analog, NiFe(CN)₆, which is selective for sodium ions. Specifically, in the embodiment of FIG. 2, the electroactive material coated on the positive electrode 131 is MnO₂, and the electroactive material coated on the negative electrode 132 is polypyrrole, so that the non-membrane deionization and ion-concentrating apparatus 100 is selective for magnesium ion and calcium ion. Based on the ion selectivity of the electroactive material 130, various types of the electroactive material 130 can be configured according to the types of charged species. Therefore, the application of the non-membrane deionization and ion-concentrating apparatus 100 of the present disclosure can be extended, and the present disclosure is not limited thereto.

When the power supply 200 applies a voltage to the current collectors 120, one of the current collectors 120 is formed as a positive electrode which adsorbs the negatively charged species (e.g., chloride ions) or discharges the positively charged species (e.g., sodium ions, calcium ions or magnesium ions). Another one of the current collectors 120 is formed as a negative electrode which adsorbs or discharges the species with opposite electrical properties. In this way, the effect of removing or concentrating charged species in the aqueous media can be achieved. Further, the electrodes are regenerated by short circuit or reverse voltage, and the charged species is desorbed or concentrated on the electrode, so that the effect of ion concentration or removal can be obtained.

As mentioned above, the electroactive material 130 exhibits a high electrosorption capacity and good ion selectivity, which cooperates with the characteristics of a high area-to-volume ratio between the microfluidic channel 110 and the fluid. Therefore, the deionization (desalination) or concentration efficiencies of the non-membrane deionization and ion-concentrating apparatus 100 of the present disclosure can be effectively enhanced. The non-membrane deionization and ion-concentrating apparatus 100 of the present disclosure does not need to be equipped with a membrane. Although the non-membrane deionization and ion-concentrating apparatus 100 of the present disclosure does not include an ion-exchange membrane, it still has high deionization and ion-concentration efficiency. The absence of the membrane can solve the problems of membrane soiling and aging, high membrane maintenance cost and complicated operation of membrane, and moreover, the energy consumption and cost of deionization and ion concentration operation can be significantly reduced. Further, the electroactive material 130 is ion-selective and can be configured with various types of materials according to the types of charged species. Therefore, the flexibility and application of the non-membrane deionization and ion-concentrating apparatus 100 of the present disclosure can be increased.

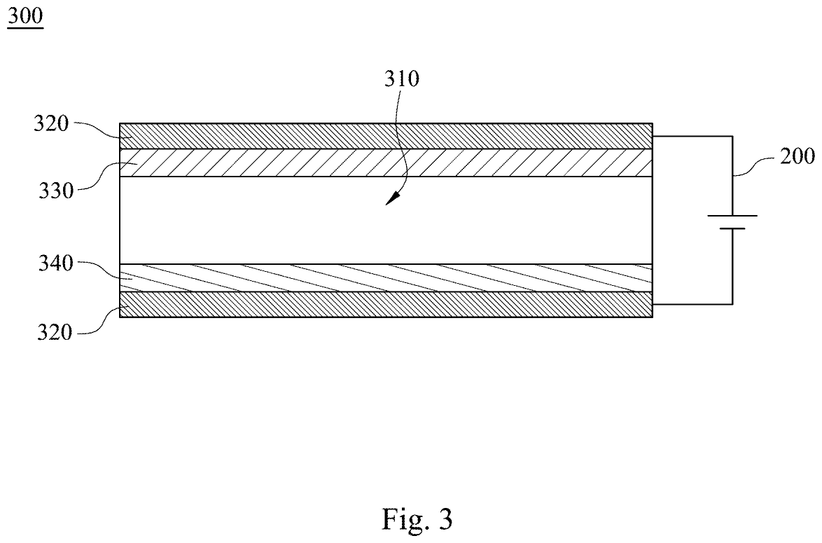

Reference is made to FIG. 3. FIG. 3 is a structure schematic view of the non-membrane deionization and ion-concentrating apparatus 300 according to another example of the embodiment of the present disclosure. The non-membrane deionization and ion-concentrating apparatus 300 includes a microfluidic channel 310, two current collectors 320, an electroactive material 330 and an electrical double layer electrode material 340. Details related to the configuration of the microfluidic channel 310, the current collectors 320 and the electroactive material 330 in FIG. 3 are similar to those of the microfluidic channel 110, the current collectors 120 and the electroactive material 130 in FIG. 2, and so these elements will not be described again.

The non-membrane deionization and ion-concentrating apparatus 300 further includes the electrical double layer electrode material 340. In FIG. 3, the electroactive material 330 is coated on one of the current collectors 320, and the electrical double layer electrode material 340 is coated on another one of the current collectors 320. Therefore, various materials can be chosen and coated according to the characteristics of the ion to be processed. When fluid flows through the microfluidic channel 310, the cell of the non-membrane deionization and ion-concentrating apparatus 300 can be hybrid, asymmetric or symmetric in design. Therefore, applications of the non-membrane deionization and ion-concentrating apparatus 300 of the present disclosure can be further expanded.

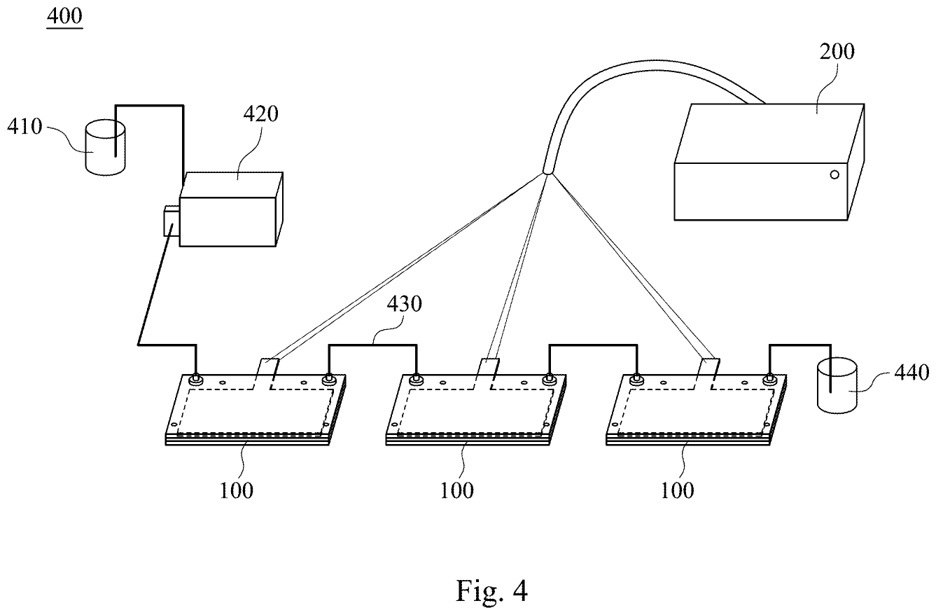

Reference is made to FIG. 4. FIG. 4 is a schematic view of a non-membrane deionization and ion-concentrating module 400 according to an example of another embodiment of the present disclosure. The non-membrane deionization and ion-concentrating module 400 is connected to the power supply 200 and includes a plurality of the non-membrane deionization and ion-concentrating apparatuses 100. It is to be noted that the embodiment in FIG. 4 is configured with the non-membrane deionization and ion-concentrating apparatus 100 as an example. However, the non-membrane deionization and ion-concentrating apparatus 300 can be also configured differently as needed, and the present disclosure is not limited in this regard.

In FIG. 4, the non-membrane deionization and ion-concentrating apparatuses 100 are connected to each other in series. In greater detail, the non-membrane deionization and ion-concentrating module 400 is connected to a sample tank 410, a pump 420 and a product tank 440 by a pipeline 430. The sample tank 410 is used to store the liquid to be processed. The pump 420 transfers the liquid in the sample tank 410 to the non-membrane deionization and ion-concentrating module 400. The liquid sequentially passes through each of the non-membrane deionization and ion-concentrating apparatuses 100 for deionization or concentration treatment so as to obtain a product. The product is collected and stored in the product tank 440.

In FIG. 4, each of the non-membrane deionization and ion-concentrating apparatuses 100 can be configured with the same or different electroactive materials. When the positive electrode and the negative electrode of each of the non-membrane deionization and ion-concentrating apparatuses 100 are configured with the same electroactive material, the deionization and concentration effect of the non-membrane deionization and ion-concentrating module 400 can be increased, and a product with high purity can be obtained. When the positive electrode and the negative electrode of each of the non-membrane deionization and ion-concentrating apparatuses 100 are configured with the different electroactive materials, each of the non-membrane deionization and ion-concentrating apparatuses 100 can process different charged species, and pure water can be obtained.

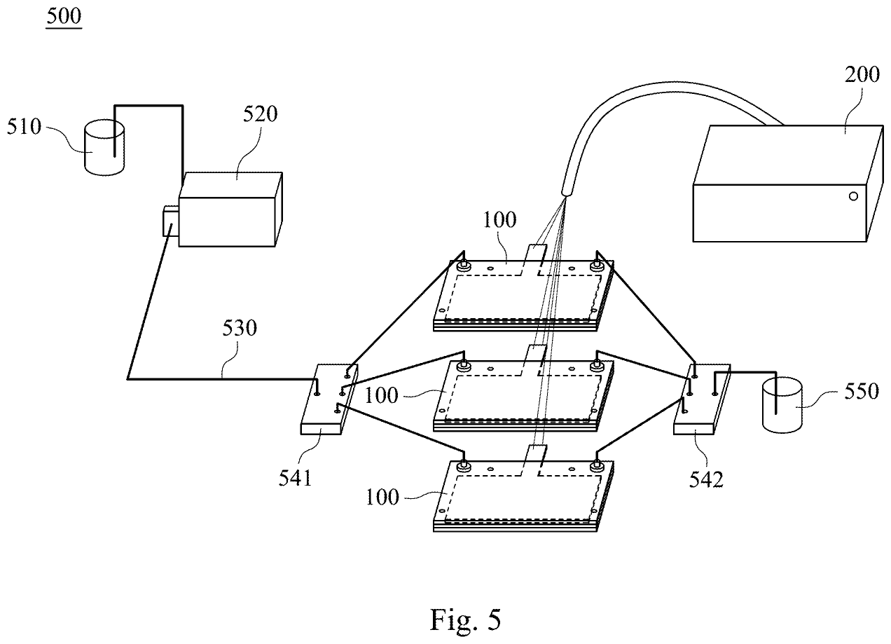

Reference is made to FIG. 5. FIG. 5 is a schematic view of a non-membrane deionization and ion-concentrating module 500 according to another example of another embodiment of the present disclosure. The non-membrane deionization and ion-concentrating module 500 is connected to the power supply 200 and includes a plurality of the non-membrane deionization and ion-concentrating apparatuses 100. In particular, the non-membrane deionization and ion-concentrating apparatuses 100 are connected to each other in parallel.

In greater detail, as shown in FIG. 5, the non-membrane deionization and ion-concentrating module 500 is connected to a sample tank 510, a pump 520, a first adapter 541, a second adapter 542 and a product tank 550 by a pipeline 530. The sample tank 510 is used to store the liquid to be processed. The pump 520 transports the liquid in the sample tank 510 to the first adapter 541. The first adapter 541 distributes the liquid into distributaries and every individual distributary passes through one of the non-membrane deionization and ion-concentrating apparatuses 100. Each of the non-membrane deionization and ion-concentrating apparatuses 100 performs the deionization or concentration treatment, so as to obtain a product. The product is collected by the second adapter 542 and stored in the product tank 550.

In FIG. 5, each of the non-membrane deionization and ion-concentrating apparatuses 100 can be configured with the same or different electroactive materials. When the positive electrode and the negative electrode of each of the non-membrane deionization and ion-concentrating apparatuses 100 are configured with the same electroactive material, the processing capacity of the non-membrane deionization and ion-concentrating module 500 can be increased. When the positive electrode and the negative electrode of each of the non-membrane deionization and ion-concentrating apparatuses 100 are configured with the different electroactive materials, the concentration of each ion in the product can be controlled.

According to the descriptions of FIGS. 4 and 5, the serial and parallel number of the non-membrane deionization and ion-concentrating module 400 and the non-membrane deionization and ion-concentrating module 500 can be adjusted according to the target concentration and the target processing capacity. Further, the non-membrane deionization and ion-concentrating apparatuses 100 can be connected to each other in series and/or in parallel at the same time. That is, the non-membrane deionization and ion-concentrating module 400 connected in series can be freely connected in series and/or in parallel with the non-membrane deionization and ion-concentrating module 500 connected in parallel, so that the applicability and the flexibility of the non-membrane deionization and ion-concentrating module of the present disclosure can be expanded.

### Example

In order to further clearly illustrate the effect of the non-membrane deionization and ion-concentrating apparatus of the present disclosure, Example 1, Example 2 and Example 3 are presented below. In greater detail, in the non-membrane deionization and ion-concentrating apparatus of Example 1, the electroactive material coated on the positive electrode is MnO₂, and the electroactive material coated on the negative electrode is polypyrrole. In the non-membrane deionization and ion-concentrating apparatus of Example 2, the electroactive material coated on the positive electrode is Prussian blue analogs, and the electroactive material coated on the negative electrode is polypyrrole. In the non-membrane deionization and ion-concentrating apparatus of Example 3, the electroactive material coated on the positive electrode is MnO₂, and the electroactive material coated on the negative electrode is activated carbon.

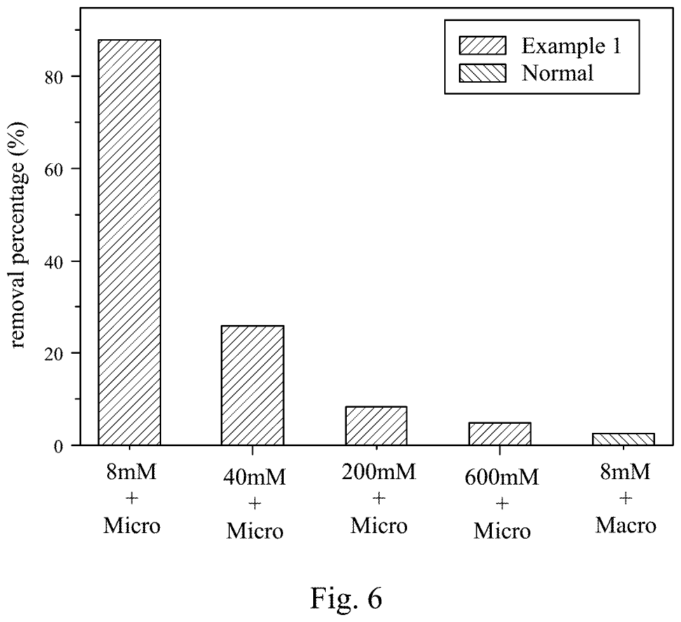

Reference is made to FIG. 6. FIG. 6 is a comparison result of the removal performance of Example 1 of the present disclosure and a normal deionization apparatus. In FIG. 6, the vertical axis is salt removal percentage (SRP), and the horizontal axis is the concentration of salt in the sample. The normal deionization apparatus refers to a circulated deionization system in which the electrodes are separated by 0.5 cm or more (macro-leveled). As can be seen from the results shown in FIG. 6, there is a significant difference in the salt removal percentage between Example 1 and the normal deionization apparatus. The salt removal percentage of Example 1 is much higher than that of the normal deionization apparatus. Further, Example 1 can work effectively in the media with salt concentration varying from 8 mM (equivalent to the concentration of brackish water or salinized groundwater) to 600 mM (equivalent to the concentration of seawater). Therefore, the non-membrane deionization and ion-concentrating apparatus of the present disclosure can treat the salinized water with various salt concentrations and can be directly applied to seawater desalination.

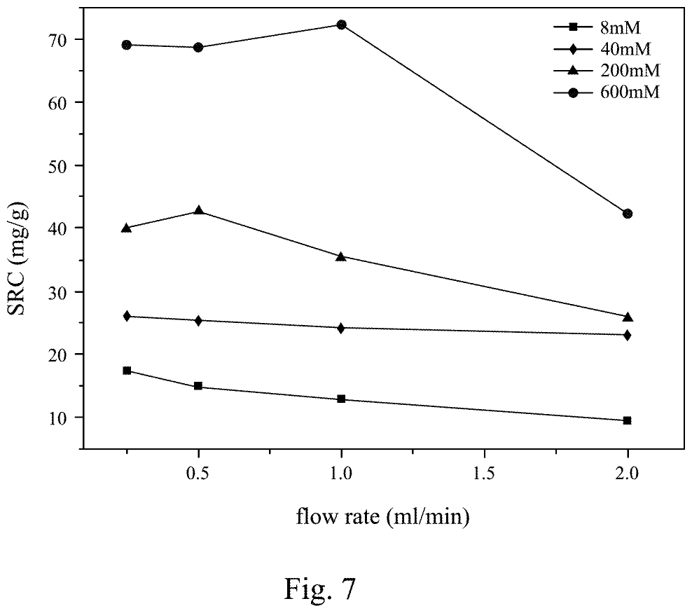

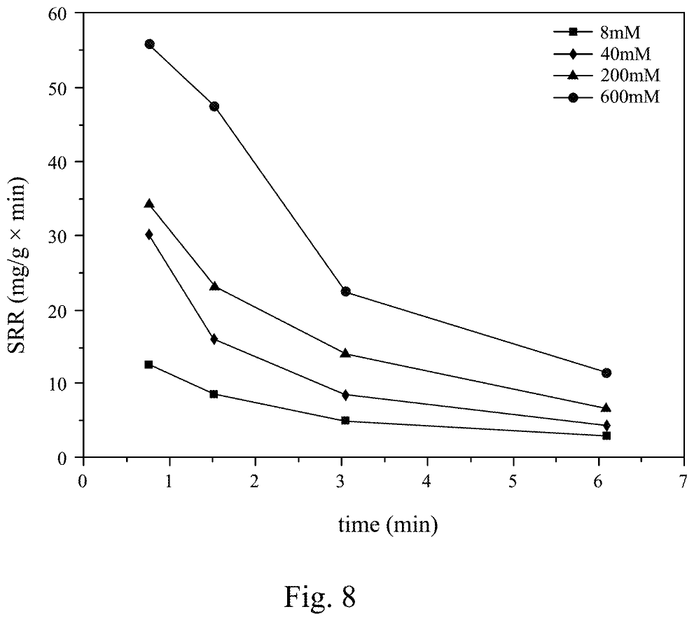

Reference is made to FIGS. 7 and 8. FIG. 7 is a relationship diagram between the flow rate and the salt removal capacity of Example 1 processing brackish water with various salt concentrations. FIG. 8 is a relationship diagram between the salt removal rate and operation time of Example 1. In FIGS. 7 and 8, the fluids containing 8 mM, 40 mM, 200 mM and 600 mM are deionized, and the data are recorded. In FIG. 7, the vertical axis is the cell salt removal capacity (SRC). In FIG. 8, the vertical axis is the cell salt removal rate (SRR). The overall performance of the non-membrane deionization and ion-concentrating apparatus can be seen from the results shown in FIGS. 7 and 8.

As shown in FIG. 7, Example 1 can effectively remove the salt from liquids with various salt concentrations. Further, the salt removal capacity is positively proportional to the salt concentration of salt in the liquid. Therefore, the non-membrane deionization and ion-concentrating apparatus of the present disclosure can treat the brackish water with various salt concentrations and can be directly applied to seawater desalination. As shown in FIG. 8, Example 1 shows a very high salt removal rate which is positively proportional to the salt concentration in the liquid. Therefore, for ions removal from water, the non-membrane deionization and ion-concentrating apparatus of the present disclosure can greatly shorten the processing time and improve the processing efficiency when removing ions from water.

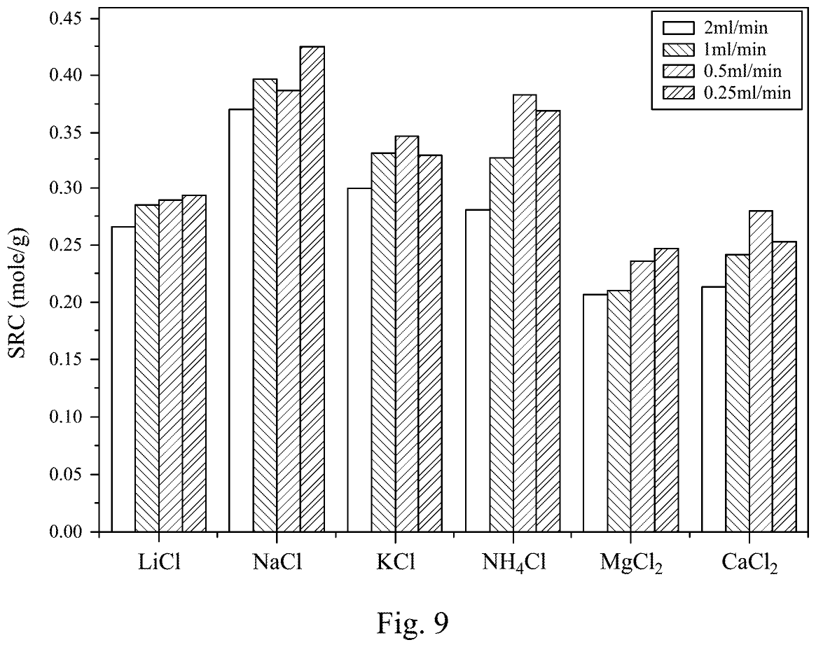

Reference is made to FIG. 9. FIG. 9 is a relationship diagram between the removal capacity of various charged species and the liquid flow rate according to Example 1. In FIG. 9, liquids containing various charged species are deionized under various flow rates of liquids. Under all flow rates, Example 1 can effectively remove these charged species. Therefore, the non-membrane deionization and ion-concentrating apparatus of the present disclosure can process liquids in various situations. Hence, the application thereof can be further extended.

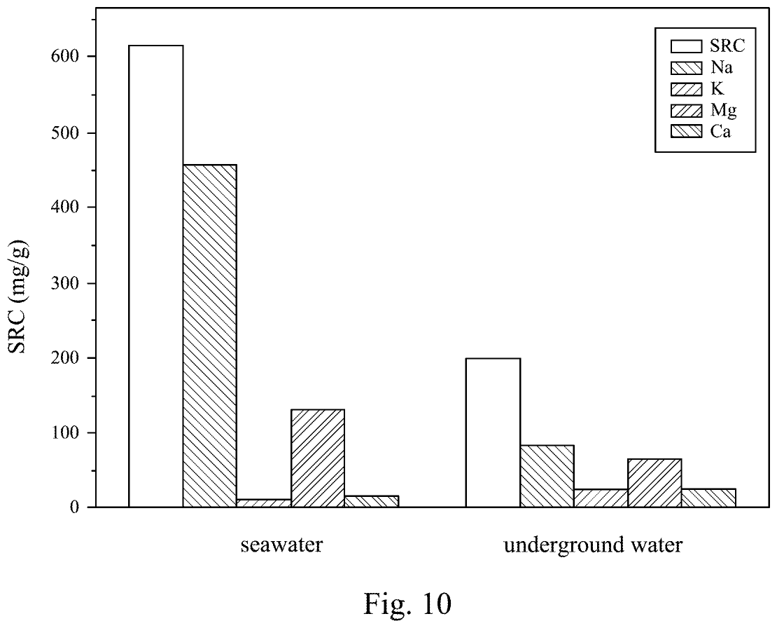

Reference is made to FIG. 10. FIG. 10 is a result of Example 1 processing in seawater and salted underground water. Specifically, real seawater and salted underground water are used for the deionization tests in FIG. 10. From the results in FIG. 10, it can be seen that Example 1 can effectively desalinate the seawater and the salted underground water. Therefore, the non-membrane deionization and ion-concentrating apparatus of the present disclosure can be directly applied to practical water desalination such as seawater desalination and salinized underground water desalination.

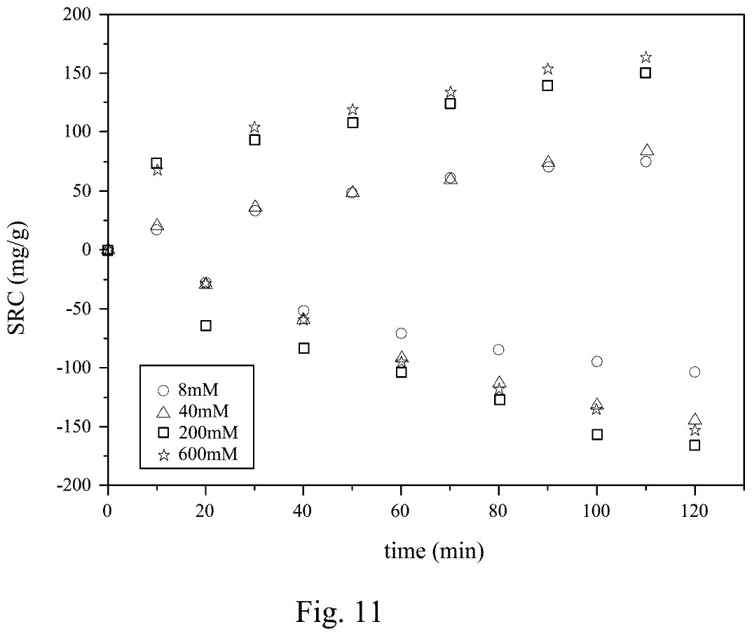

Reference is made to FIG. 11. FIG. 11 is a relationship diagram between the salt removal capacity/salt-concentrating capacity and operation time in salinized water with various concentrations according to Example 1. In greater detail, in FIG. 11, liquids containing various salt concentrations are tested. Example 1 is discharged and charged to make the current collectors adsorb and desorb the ion in two separated solution tanks. As shown in the results in FIG. 11, Example 1 exhibits quite high efficiencies in both ion adsorption and ion desorption. The non-membrane deionization and ion-concentrating apparatus of the present disclosure has excellent performance in both deionization and ion-concentrating, and can be applied to liquids with various salt concentrations.

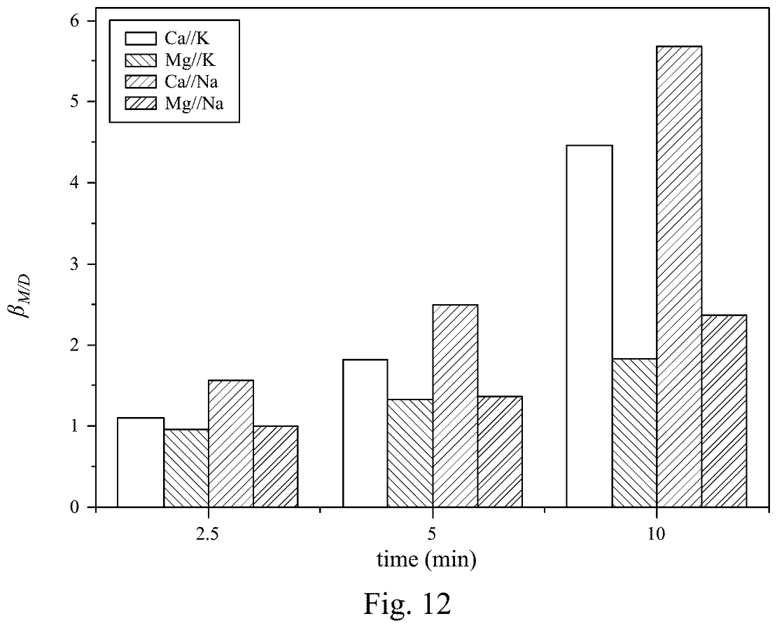

Reference is made to FIG. 12. FIG. 12 is a relationship diagram between the ion selectivity and operation time according to Example 1. Specifically, in FIG. 12, the vertical axis represents the ion selectivity which is defined as the following formula:

$${β}_{M / D} = ( \frac{{C}_{M , initial} - {C}_{M , final}}{{C}_{D , initial} - {C}_{D , final}} ) \times ( \frac{{C}_{D , initial}}{{C}_{M , initial}} ) .$$

From the results in FIG. 12, Example 1 exhibits better selectivity for magnesium ions and calcium ions. Therefore, through the arrangement and selection of electroactive materials, the non-membrane deionization and ion-concentrating apparatus of the present disclosure can process specific charged species, and the application thereof can be increased.

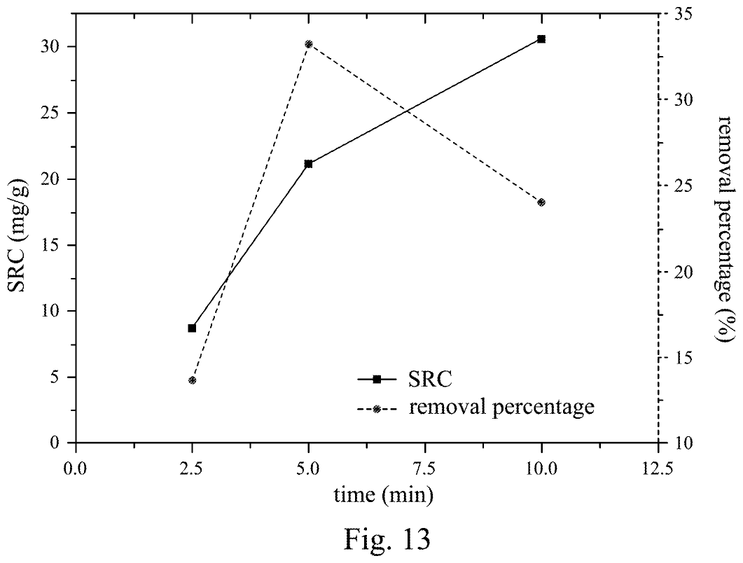

Reference is made to FIG. 13. FIG. 13 is a relationship diagram between the salt removal capacity and operation time as well as between the salt removal percentage and operation time of Example 2. As shown in FIG. 13, Example 2 also has excellent ion removal ability and high ion removal percentage. Example 2 proves that the non-membrane deionization and ion-concentrating apparatus of the present disclosure configured with different electroactive materials can also achieve excellent removal capacity, and the applicability of the non-membrane deionization and ion-concentrating apparatus of the present disclosure can be increased.

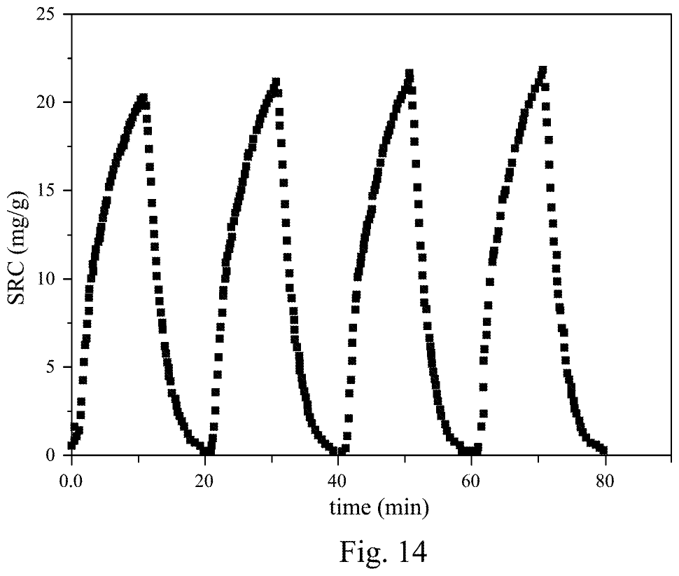

Reference is made to FIG. 14. FIG. 14 is a cycling test diagram for the salt removal capacity against operation time of Example 3. In Example 3, the positive electrode is coated with the electroactive material, and the negative electrode is coated with activated carbon. As shown in FIG. 14, the structure of single electroactive material with the microfluidic channel can still retain good desalination ability, so that the application field and flexibility of the non-membrane deionization and ion-concentrating apparatus of the present disclosure can be increased.

In summary, the salt removal efficiency and salt removal percentage of the non-membrane deionization and ion-concentrating apparatus of the present disclosure can be improved by selecting the electroactive materials having the high electrosorption capacity and the characteristics of a high area-to-volume ratio between the microfluidic channel and the fluid. With such a configuration, the non-membrane structure configuration can be achieved, and the problems of membrane soiling and aging, high membrane maintenance cost and complicated operation of membrane-based devices can be solved. Moreover, the energy consumption and cost of deionization and ion concentration operation can be significantly reduced. Further, the non-membrane structure configuration facilitates the modularization of the deionization and ion-concentrating module. Since the structure is not limited by the membrane, a plurality of the non-membrane deionization and ion-concentrating apparatuses can be arbitrarily connected to each other. Therefore, the convenience of assembling the non-membrane deionization and ion-concentrating apparatus of the present disclosure can be increased, and the fluid volume, concentration range and ion selectivity of the deionization and ion concentration can be expanded, and the application thereof can be more flexible and extensive.

Although the present disclosure has been described in considerable detail with reference to certain embodiments thereof, other embodiments are possible. Therefore, the spirit and scope of the appended claims should not be limited to the descriptions of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure, provided they fall within the scope of the following claims.

What is claimed is:

1. A non-membrane deionization and ion-concentrating apparatus connected to a power supply and comprising:
a microfluidic channel;
two current collectors, wherein the microfluidic channel is disposed between the two current collectors, and the power supply applies a voltage to the two current collectors; and
an electroactive material coated and connected to at least one of the two current collectors, wherein the electroactive material has a reversible redox ability.

2. The non-membrane deionization and ion-concentrating apparatus of claim 1, wherein a width of the microfluidic channel is 1 μm to 300 μm.

3. The non-membrane deionization and ion-concentrating apparatus of claim 1, wherein a mass loading of the electroactive material is from 0.5 mg/cm² to 25 mg/cm².

4. The non-membrane deionization and ion-concentrating apparatus of claim 1, further comprising:
an electrical double layer electrode material, wherein the electroactive material is coated on one of the two current collectors, and the electrical double layer electrode material is coated on another one of the two current collectors.

5. The non-membrane deionization and ion-concentrating apparatus of claim 1, wherein when the power supply applies the voltage to the two current collectors, one of the two current collectors is formed as a positive electrode, and an electroactive material coated on the positive electrode is a metal, an alloy, a transition metal oxide, a transition metal sulfide, a transition metal carbide, an anionic polymer, a Prussian blue analog, an organic electrode material, an organometallic compound, a polyoxymethylene, a composite of the above materials or a composite of the above materials with a conductive carbon material.

6. The non-membrane deionization and ion-concentrating apparatus of claim 1, wherein when the power supply applies the voltage to the two current collectors, one of the two current collectors is formed as a negative electrode, and an electroactive material coated on the negative electrode is a metal, an organic electrode material, an organometallic compound, a transition metal carbide, a composite of the above materials or a composite of the above materials with a conductive carbon material.

7. The non-membrane deionization and ion-concentrating apparatus of claim 1, wherein the electroactive material is ion-selective for an ion to be processed.

8. The non-membrane deionization and ion-concentrating apparatus of claim 1, wherein the non-membrane deionization and ion-concentrating apparatus does not comprise an ion-exchange membrane.

9. A non-membrane deionization and ion-concentrating module connected to a power supply and comprising:
a plurality of the non-membrane deionization and ion-concentrating apparatuses of claim 1, wherein the non-membrane deionization and ion-concentrating apparatuses are connected to each other.

10. The non-membrane deionization and ion-concentrating module of claim 9, wherein the non-membrane deionization and ion-concentrating apparatuses are connected to each other in parallel.

11. The non-membrane deionization and ion-concentrating module of claim 9, wherein the non-membrane deionization and ion-concentrating apparatuses are connected to each other in series.

12. The non-membrane deionization and ion-concentrating module of claim 9, wherein the non-membrane deionization and ion-concentrating apparatuses are connected to each other in parallel and series.
